(19) United States
(12) Patent Application Publication
(10) Pub. No.: US 2019/0373914 A1
(43) Pub. Date: Dec. 12, 2019

(54) Foodstuff Having Increased Protein Content

(71) Applicant: Board of Trustees of Michigan State University, East Lansing, MI (US)

(72) Inventor: Venkatesh Balan, Sugar Land, TX (US)

(21) Appl. No.: 16/433,542

(22) Filed: Jun. 6, 2019

Related U.S. Application Data
(60) Provisional application No. 62/683,170, filed on Jun. 11, 2018.

(51) Int. Cl. A23J 3/30; A23L 31/00; A23L 5/10; A23P 10/40

(52) U.S. Cl. CPC A23J 3/30; A23L 31/00; A23V 2002/00; A23P 10/40; A23L 5/15

(57) ABSTRACT

A foodstuff includes a mushroom slice having a native protein content and a hydrolyzed animal and/or plant protein disposed on the mushroom slice to increase a total protein content thereof. The total protein content of the mushroom slice including the hydrolyzed animal and/or plant protein is 10 to 50 weight percent greater than that native protein content of the mushroom slice.

### RELATED APPLICATIONS

This application claims priority to and the benefit of U.S. Provisional Patent Application 62/683,170, filed Jun. 11, 2018, the disclosure of which is hereby incorporated by reference in its entirety.

### FIELD OF THE DISCLOSURE

The disclosure generally relates to a foodstuff having an increased total protein content. More specifically, this disclosure relates to a mushroom slice and a hydrolyzed animal and/or plant protein disposed thereon which increases a total protein content of the mushroom slice.

### BACKGROUND

In the recent years, salty snacks have gained popularity among individuals of all age groups. Some salty snacks, such as mixed vegetable chips, are becoming more popular and are sold in niche markets mostly in Western Europe and, to a lesser extent, in North America. However, shifting diet trends may impact food purchasing in the future. For example, people with celiac disease and those suffering from gluten intolerance tend to avoid snacks containing wheat. Due to growing health concerns and awareness, consumers are also attempting to make healthy snack choices by avoiding ingredients such as fat, sugar, cholesterol and sodium and are increasingly selecting baked and salt-free multigrain chips. Recently, organic and non-GMO ingredients have received more attention by consumers, which has created a demand for new products in this category. Consumers who are concerned about nutrition tend to look for quality ingredients and minimally processed foods.

As a result, snack manufacturers are experimenting with new vegetable and fruit products that have lower amounts of acrylamide, a neurotoxin carcinogen, when compared to fried chips. Seasoning and taste profiles are other important elements that appeal to consumers. A variety of snacks that are sold in the market are starch-based with less protein content than traditional foodstuffs, such as potato chips. Some snacks are energy dense and coated with sugar syrup, corn syrup, or chocolate. However, consuming energy dense snacks beyond the recommended portion sizes, coupled with sedentary behaviors, may lead to obesity and several diet related chronic diseases. As such, there is a need for a healthy alternative to conventional salty and starch rich snacks.

### SUMMARY OF THE DISCLOSURE

A foodstuff includes a mushroom slice having a native protein content and a hydrolyzed animal and/or plant protein disposed on the mushroom slice to increase a total protein content thereof. The total protein content of the mushroom slice including the hydrolyzed animal and/or plant protein is 10 to 50 weight percent greater than that native protein content of the mushroom slice.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a bar graph of taste profile of various Examples;

FIG. 2 is a bar graph of appearance profile of various Examples;

FIG. 3 is a bar graph of texture profile of various Examples; and

FIG. 4 is a bar graph of comparison of hydrolyzed collagen protein and hydrolyzed soy protein of various Examples.

FIG. 5 is a table illustrating the nutritional composition of one embodiment of a foodstuff of this disclosure.

### DETAILED DESCRIPTION OF THE DISCLOSURE

This disclosure provides a foodstuff including a mushroom slice having a native protein content and a hydrolyzed animal and/or plant protein disposed on the mushroom slice to increase a total protein content thereof. The total protein content of the mushroom slice including the hydrolyzed animal and/or plant protein is 10 to 50 weight percent greater than that native protein content of the mushroom slice without the hydrolyzed animal and/or plant protein disposed thereon.

The foodstuff is a substance suitable for consumption as food. For example, the foodstuff may be any substance that provides nutritional support for the body. Foodstuffs are typically of plant or animal origin and typically include essential nutrients such as carbohydrates (free sugars, dietary fiber, and starch), fats, proteins, vitamins, or minerals. The foodstuff can be ingested and assimilated to provide energy, maintain life, or stimulate growth.

The foodstuff includes a mushroom slice, as described in greater detail below. The mushroom slice is, more specifically, a slice of a mushroom. There are many different species of edible mushrooms. A mushroom is the fleshy, spore-bearing fruiting body of a fungus that can be grown above ground on soil. In one embodiment, the mushroom species is Pleurotus eryngii. The Pleurotus eryngii species may also be known as king trumpet mushroom, French horn mushroom, king oyster mushroom, king brown mushroom, boletus of the steppes, trumpet royale, or Ali'i Oyster. In other embodiments, the mushroom species may be Calocybe indica (Milky White mushroom), Tricholoma crissum (Rinofoot mushroom), Macrocybe crassa (Rinofoot mushroom), Macrocybe titans (Florida mushroom), Pleurotus nebrodensis (Funciu di basilicu), or Pleurotus ferulae (White Elf mushroom). However, it is to be appreciated that any species of edible mushroom could be used.

The Pleurotus eryngii mushrooms, or king oyster mushrooms, tend to have a native protein content of from 5% to 20% on a dry weight basis. The weight (or, for example, concentration) of protein in mushrooms tends to be greatly influenced by the species of mushroom, the time taken to grow the mushroom, growing conditions, the substrate used to grow the mushroom, and the composition used for cultivating the mushroom.

As first introduced above, the foodstuff includes or is the mushroom slice. The slice itself is formed from the mushroom by cutting a portion of the mushroom. The mushroom slice tends to be a thin, and optionally flat, piece or portion of the mushroom. The mushroom slice may have any thickness. For example, the thickness may be of from 1 mm to 5 mm, or from 1 mm to 3 mm, or from 3 mm to 5 mm, or from 2 mm to 3 mm, or from 3 mm to 4 mm. In various non-limiting embodiments, all values and ranges thereof including and between those values set forth above are hereby expressly contemplated for use.

The mushroom slice is not limited to any particular shape. For example, the mushroom slice may be oval and/or circular. In other embodiments, the mushroom slice is a horizontal or vertical cross-sectional shape of the mushroom. The mushroom slice may be easily picked up and manipulated by a human hand to be consumed. The mushroom slice is not limited in size and may have any length, width, and height (thickness). For example, the mushroom slice may have an approximate length of from 1 cm to 15 cm, from 1 cm to 7 cm, or from 7 cm to 15 cm. In other embodiments, the mushroom slice has an approximate width of from 1 cm to 15 cm, from 1 cm to 7 cm, or from 7 cm to 15 cm. It is to be appreciated that any sharp implement may be used to form the mushroom slice. In various non-limiting embodiments, all values and ranges thereof including and between those values set forth above are hereby expressly contemplated for use.

The mushroom slice has a native protein content, i.e., a natural content of protein that exists in the mushroom. This protein content may vary depending on the species of mushroom. The native protein content may be measured and reported as weight percent or, in other words, a weight of natural proteins present in the mushroom compared to a weight of the entire mushroom. The native protein content can be reported relative to the mushroom slice or the mushroom as a whole that is used to form the mushroom slice. If reported relative to the mushroom slice, then the weight basis of the native protein content is the weight of the mushroom slice. The identification of the specific native proteins present in the mushroom/mushroom slice may be any known in the art that are present.

In this disclosure, the native protein content is supplemented through use of a hydrolyzed animal and/or plant protein disposed on the mushroom slice. In other words, a total protein content of the mushroom slice, after addition of the hydrolyzed animal and/or plant protein, is greater than the native protein content before addition or without addition. The hydrolyzed animal and/or plant protein adds protein to the mushroom slice and is disposed thereon. The terminology “disposed thereon” tends to describe that the hydrolyzed animal and/or plant protein is disposed on, and in direct contact with, the mushroom slice. Alternatively, the terminology “disposed thereon” may describe that the hydrolyzed animal and/or plant protein is disposed on, and separated apart from, the mushroom slice, e.g. separated by a layer of an additive or seasoning, as described in greater detail below.

The total protein content of the mushroom slice including the hydrolyzed animal and/or plant protein is 10 to 50 weight percent greater than that native protein content. In various embodiments, the total protein content is 10, 11, 12, 13, 14, 15, 16, 17, 18, 19, 20, 25, 30, 35, 40, 45, or 50, weight percent greater than the native protein content. In various non-limiting embodiments, all values and ranges thereof including and between those values set forth above are hereby expressly contemplated for use.

The hydrolyzed animal and/or plant protein is not particularly limited and may be any known in the art. For example, the hydrolyzed animal and/or plant protein may be derived from protein of peas, soy, milk, eggs, rice, collagen, and combinations thereof. It is to be appreciated that any appropriate source of protein known in the art may be used as the hydrolyzed animal and/or plant protein. In one embodiment, a hydrolyzed animal protein is used, e.g. to the exclusion of any plant proteins. In another embodiment, a hydrolyzed plant protein is used, e.g. to the exclusion of any animal proteins. In yet another embodiment, both a hydrolyzed animal protein and a hydrolyzed plant protein may be used. Moreover, one or more of the aforementioned proteins may be used. In even further embodiments, the hydrolyzed animal and/or plant protein may include less than 5, 4, 3, 2, 1, 0.5, or 0.1 weight percent of, or be free of, proteins that are not hydrolyzed animal and/or plant proteins.

Typically, and as known in the art, hydrolyzed proteins are proteins that have been hydrolyzed or broken down into component amino acids or peptides using protease enzyme. A hydrolyzed animal and/or plant protein is typically a hydrolyzed protein wherein the component amino acids or peptides are derived from an animal and/or plant, respectively. It is to be appreciated that the hydrolyzed animal and/or plant protein may be from any plant and/or animal source.

In additional embodiments, the mushroom slice includes one or more plant extracts, e.g. disposed thereon. The additives and/or plant extracts may be any known in the art and are not particularly limited. In various embodiments, the plant extract is chosen from Acaica catechu Heart wood, Adenophora, Adhatoda vasica, Adulsa Extract, Agave Sisalana, Agrimory, Aiye Leaf, Akebia Caulis, Alfalfa Leaf, Alisma, Almond, Aloe Vera Extract, Alpine Herb Extract, Althaea Officinalis Extract, American Ginseng extract, Amica Extract, Amla Extract, Ammi Visnaga, Andrographis Paniculata, Anemarhenae Asphodeliodes, Angelica Root, Angelicae Pubescentis, Arjuna, Artichoke, Ashwagandha, Asian ginseng extract, Asiasari radix extract, Asparagus Root, Astragalus/Bay Chi, Avocado Extract, Bacopa monnieri (Brahmi), Baheda, Bala, Banaba Extract, Barberry, Barley Grass Powder, Basibolol, Belladonna Leaf, Betulae folium extract, Bhringraj Extract, Bilberry, Birch Extract, Bitter Melon, Bitter Sophora Root, Black Bean Peel, Black Cohosh extract, Black Sesame Extract, Blackberry Extract, Boswellia Serrata, Brahmi Extract, Brussel sprout powder, Bufonis Venenum Extract, Bulgarian Tribulus, Bupleurum, Burdock Seed/root extract, Butea Superba, Cabbage Extract, Calendula Officinalis, Capcicum Extract, Caralluma fimbriata, Carline Thistle, Carrot Extract, Carum Carvi, Caryophylli flos, Cascara Sagrada, Cassia Nomame, Cassia Tora/Juemingzi, Cat's Claw, Caulis Spatholobi, Celandine Fluid Extract, Celery, Centella asiatica, Cepae, Chalcone polymers, Chamomile, Chasteberry, Chicory, Chinese wolfberry powder, Chlorella Powder, Chrysanthemum, Chrysin, Cinamomi cortex, Cinidium, Cinnamon Bark, Cistanche deserticola Ma, Cistanchis herba, Citrus Aurantinum, Citrus bioflavonoids, Clary Sage, Cloves, Coccinia indica, Cocos Nucifera, Codonopsis Root, Cola Nut, Coleus Forskohlii, Commiphora myrrh, Coptis Root, Cordyceps Extract, Coriolus Mushroom/Yunzhi, Cornsilk (Job's Tears Extract), Corus officinals, Corydalis Yanhusuo W. T. Wang, Cranesbill, Cucumber Extract, Curcumin, Cuscutae Seed (Dora), Dahurian Rhodoendron Leaf, Damiana Dried, Dandelion leaf extract, Devil's Claw, Dried Fennel, Dryopteris, Echinacea Angustifolia, Echinacea Purpurea Herb, Elecampane Flower/root extract, Epimedium, Eucalyptus leaves, Eucommia Bark/leaf extract, Eurycoma Longifolia, Evodia, Eyebright Herb, Fennel Seed extract, Fenugreek Dried extract, Fever Few, Flaxseed Hull Extract, Fo Ti/Ho Shou Wu, Forsythia suspensa extract, Fucus Vesiculosus, Garcinia Cambogia fruit extract, Garlic Extract, Gastrodia Rhizoma, Gentian Root, Ginger Extract, Gingko Biloba extract, Glucomannan, Glycyrrhiza glabra, Gokhru, Golden rod extract, Golden Seal Root, Gotu Kola Herb, Grape Fruit Extract, Grape Seed extract, Grape Skin, Green Tea Caffeine, Green Tea Catechins, Green Tea EGCg, Green Tea extract, Green Tea Theanine, Griffonia Simplicifolia Extract, Guarana extract, Guduchi, Guggul, Gymnema Sylvestre, Gynostemma, Harda, Hawthorn leaf/berry extract, Hedyotis diffusa, Heena Extract, Hibiscus Flower extract, Honey Extract, Honey Suckle Flower/stem extract, Hoodia Gordonit, Hop extract, Hops Flower, Horny goat weed extract, Horse Chest Nut extract, Horsetail, Houttuynia, Huperzia Serrata, Hydrangea Root, Iberis Amara mother tincture, Inula racemosa, Isatis indigotica fort, Isatis root extract, Ivy Extract, Jaiphal, Jamun Extract, Jasmine Tea, Jatamasi Extract, Javitri, Jethimadhu, Kale powder, Karanj, Karela, Kawa Kawa, Kawach (Kapikachu), Kiwi Fruit, Kola Nut, Korean Ginseng extract, Laminana Sacchanina, Lemon Balm (Melissa), Lemon Fruit/peel Extract, Licorice Root, Ligustrum, Liquorice, Lobelia Intiata, Longan Aril, Lonicera japonica extract, Loquat Leaves, Lotus Extract, Lovage, Luo Han Guo, Lycium, Lycopene Tomato, Lycoris radiata Herb, Ma Huang Powder, Macleaya cordata, Magnolia Bark, Maitake Mushroom, Malva Verticillata, Mangosteen Extract, Manjistha Extract, Marigold extract, Meadowsweet Extract, Medicago, Melissa officinalis, Meswak Extract, Methi Extract, Milk Thistle Seed Extract, Morinda Citrifolia, Morinda Root, Motherwort, Moutan Black, Mucuna pruriens, Mugwort extract, Mulberry Berry/leaf extract, Mustard Seed, Nardostachytis, Neem Extract, Nettle Root/Leaf extract, Nirgundi, Notoginseng Leaf/root extract, Notopterygium Root, Nuphar Pumilum Root, Nutgrass, Oat Straw, Ocimum sanctum, Oleanolic acid, Oleoresin capsicum, Onion Extract, Oolong Tea, Ophiopogonis, Orange Fruit/peel Extract, Organic Eleuthero, Paeonia lactiflora Pall, Papain extract, Papaya Extract, Parsley, Passiflora incarnata, Passion Flower, Peach Extract, Peppermint extract, Perilla seed Extract, Petroselini radix extract, Phaseoli Percarpium Extract, Phyllanthus emblica, Pine Bark Extract, Pineapple Extract, Pinelliae, Piper longum, Piper nigrum, Plantago herb/seed extract, Plantain extract, Podophyllotoxin, Podophyllum hexandrum, Pomegranate Extract, Poncirus, Poria Cocos, Portulaca Oleracia, Primulae extract, Prune powder, Pu Erh Tea, Pueraria/Kudzu, Pumpkin Seed, Pygeum Africanum, Quercetin, Rabdosia japonica Hara, Radix Platycodi, Radix Stemonae, Raspberry seed extract, Rauwolfia serpentine, Red Clover extract, Red Peony, Red Rice Yeast, Red Wine Extract, Reishi Mushroom, Rhizoma Drynaria, Rhodiola, Rhubarb Root, Rose Extract, Rosehips, Rosemary Extract, Royal Jelly Powder, Salacia Reticulata, Salvia Root, Sarsaparilla Root, Saullea Vaginate, Saw palmetto extract, Sceletium extract, Schizandra fruit extract, Schizenepeta extract, Scopolia Extract, Scultellaria Root, Sea Weed Extract, Semen Coiois, Semen Cuscutae, Senegae extract, Senna Leaf, Shatavari Extract, Shavegrass, Sheelajit, Shiitake Mushroom, Shikakai Extract, Siberian Ginseng, Siberian Milkwort, Sida cordifolia, Siler, Silybum marianum, Sinomenine, Soy extract, Soy Isoflavones, Spinach Extract, Spirulina Powder, St. John Wort Extract, Stemonae, Stephania cepharantha Hayata, Stevia Extract, Strawberry powder, Summa Root, Sunflower Extract, Tagar, Tart cherry powder, Tea Saponin, Teasel Root, Terminalia bellerica, Terminalia chebula, Theaflavins, Thymus leaves, Tinospora crispa, Tomato Extract, Torilis Japonica, Tribulus Terrestris, Triphala, Tulsi Extract, Turmeric Extract, Uva Ursi Leaf (Xiong Guo), Valerian Root, Vitex agnus-castus, Vitex/Chasteberry, Vitis idaeae follum extract, Watermelon Extract, Wheat Grass, Wheat Protein Extract, White Atractrylodes, White Peony, White Tea, White Willow Bark extract, Wild Yam Extract, Witch Hazel extract, Wormwood, Yerbamate Extract, Yohimbe Bark, Zeodary Root, Ziziphi, and combinations thereof.

In further embodiments, the mushroom slice includes one or more vitamins and/or minerals, e.g. disposed thereon. The additives and/or vitamins and/or minerals may be any known in the art and are not particularly limited. In various embodiments, the vitamins and/or minerals are chosen from vitamin C, B1, B2, B3, B5, B6, B9, B12, biotin, A, E, D, K, potassium, iodine, selenium, borate, zinc, calcium, magnesium, manganese, molybdenum, betacarotene, iron, thiamin, riboflavin, niacin, folate, phosphorus, copper, and combinations thereof.

In additional embodiments, the mushroom slice includes one or more flavor profiles. The flavor profiles may be salty, sweet, savory, spicy, sour, bitter, nutty, chocolatey, and combinations thereof. The flavor profiles include additives, e.g. seasonings, disposed on the mushroom slice. The additives and/or seasonings may be any known in the art and are not particularly limited. In various embodiments, the seasoning is chosen from salt, herbs, spices, and combinations thereof to enhance the flavor of the mushroom slice. For example, the seasoning may be alternatively chosen from all-spice, coriander, cumin, oregano, garlic powder, cinnamon, chili powder, nutmeg, cloves, ginger, thyme, rosemary, cardamom, paprika, turmeric, cayenne pepper, bay leaves, cajun seasoning, basil, garlic, curry powder, garam masala, jalapeno, cheese, salt, pepper, sugar, onion powder, lemon, barbeque flavoring, chocolate, coco powder, fruit, freeze dried fruit, artificial fruit flavoring, coffee, tea and combinations thereof. It is to be appreciated that any combination of herbs and/or spices may be used as seasoning. It is also contemplated that the hydrolyzed animal and/or plant protein may also provide flavor or may be flavorless.

The foodstuff or mushroom slice may or may not increase in thickness after addition of the hydrolyzed animal and/or plant protein, seasoning, other additives described above. For example, the mushroom slice may have an approximate increased thickness of from 0 mm to 1 mm, from 0 mm to 0.25 mm, or from 0.25 mm to 1 mm. In other embodiments, the thickness does not change or changes by less than 0.3 mm, 0.2 mm. or 0.1 mm. In various non-limiting embodiments, all values and ranges thereof including and between those values set forth above are hereby expressly contemplated for use.

In other embodiments, the texture of the mushroom slice is not changed by the hydrolyzed animal and/or plant protein disposed thereon. In yet another embodiment, the appearance of the mushroom slice is not changed by the hydrolyzed animal and/or plant protein disposed thereon. In a further embodiment, the foodstuff may have a uniform appearance. The unchanged texture, unchanged appearance, and uniform appearance of the foodstuff may appeal to consumers.

The mushroom slice and hydrolyzed animal and/or plant protein disposed thereon are typically baked to form a baked product, such as a mushroom crisp or chip. However, it is also contemplated that the mushroom slice and hydrolyzed animal and/or plant protein disposed thereon may be served raw or may be cooked, heated, or otherwise prepared via any method known in the art, e.g. frying, freeze-drying, etc. Various methods are described in detail below.

Method of Preparing the Foodstuff:

This disclosure also provides a method of preparing the foodstuff. The method includes the step of slicing the mushroom to form the mushroom slice. The step of slicing may be further described as any known in the art. For example, any slicing device or knife may be utilized. In various embodiments, the mushroom is sliced into slices with a thickness described above.

The method also includes the step of disposing the hydrolyzed animal and/or plant protein on the mushroom slice to form the foodstuff. The step of disposing increases the total protein content of the mushroom slice to a content that is 10 to 50 weight percent greater than the native protein content of the mushroom slice alone.

The hydrolyzed animal and/or plant protein may be disposed in a variety of methods. In one embodiment, the step of disposing is further defined as spraying the hydrolyzed animal and/or plant protein on the mushroom slice. Spraying can describe applying a liquid to the mushroom slice in the form of a shower of tiny droplets. In other words, spraying may be defined as driving a solution of the hydrolyzed animal and/or plant protein through the air or forcing the solution out of a spraying apparatus in the form of small drops or mist. In another embodiment, the step of disposing is further defined as dipping the mushroom slice, e.g. in a solution of the hydrolyzed animal and/or plant protein. Dipping may be described as plunging or immersing the mushroom slice momentarily or partially under the surface of the solution. In other words, the mushroom slice may be lowered and then raised again in the solution. In yet another embodiment the hydrolyzed animal and/or plant protein may be in a dry form. The step of disposing is further defined as dispensing the dry hydrolyzed animal and/or plant protein on the mushroom slice. Dispensing can describe mechanically or manually sprinkling a dry hydrolyzed animal and/or plant protein on to the mushroom slice in small particles. In alternative embodiments, the step of disposing may be further described as brushing, coating, etc. It is to be appreciated that the hydrolyzed animal and/or plant protein may be disposed in any way known in the art.

In one embodiment, the method also includes the step of baking the mushroom slice and the hydrolyzed animal and/or plant protein at a temperature of from of 60° C. to 100° C. for a time of from 2 to 8 hours to form the foodstuff, as first introduced above. In various embodiments, the temperature is from 70 to 90, 70 to 80, or 80 to 90, ° C. In other embodiments, the time is from 3 to 7, 4 to 6, or about 5, hours. The temperature and time may be modified by those of skill in the art. Similarly, the temperature and/or time may be applied to any method of cooking, heating, or preparing, as described above. In various non-limiting embodiments, all values and ranges thereof including and between those values set forth above are hereby expressly contemplated for use.

The baking temperature of the mushroom slice typically plays a role in flavoring that gives good taste during consumption. Baking temperatures may be varied based on moisture content of the mushroom slice, amount and kind of hydrolyzed protein disposed thereon, amount and kind of seasoning disposed thereon, and type of device used. Temperatures lower than 60° C. may not give the foodstuff a good texture. Use of temperatures above 100° C. can cause over-browning of the foodstuff to give an unpleasant flavor.

The baking time, like baking temperature, may also vary depending on moisture content of the mushroom slice, amount and kind of hydrolyzed protein disposed thereon, amount and kind of seasoning disposed thereon, and type of device used.

In various embodiments, an oven is utilized. An oven is a thermally insulated chamber used for the heating, baking, or drying of a substance. The oven can be an electric oven. An electric oven is an oven with an integrated electrical heating device to cook or bake. The oven can alternatively be a gas oven. The oven can alternatively be a vacuum oven. A vacuum oven is a type of oven in which the product within the oven is surrounded by a vacuum during the baking or cooking. The absence of air or other gases prevents oxidation, prevents heat loss from the product through convection, and removes sources of contamination. The oven may be a forced air oven. A forced air oven is an oven with a fan. The fan helps to distribute heat evenly around the oven, which prevents the oven from having cold or hot spots. A forced air oven provides uniform heating throughout the oven chamber, as compared to an electric oven. The oven may also be heated by a hot fluid circulated through a heat exchanger within the oven. The fluid can be any known in the art, for example, water (steam) or oil. The type of oven is not limited herein.

Other commonly used baking methods can include use of regular far-infrared dryers, vacuum far-infrared dryers, vacuum freeze dryers, vacuum microwave puffing dryers, vacuum microwave dryers, gradient type microwave puffing dryers, etc. The mushroom slice may travel through a conveying tray in a forced air baking oven in a continuous baking process. It is to be appreciated that any of the above mentioned ovens and dryers described above may be used to bake the mushroom slice.

In yet other embodiments, additional method steps may be utilized. For example, the method may include the step of washing and/or cleaning the mushroom and/or mushroom slice, e.g. prior to slicing or after. This can be accomplished in a variety of different ways. In one particular embodiment, water and friction may be applied to a surface of the mushroom and/or mushroom slice. For example, the friction may be applied by hand or by a commercial cleaning apparatus. In addition, the friction may be applied by a spray of water and/or cleaning solution us a spray jet or using a power washing system. In yet another embodiment, a wet towel may be used to clean the dirt from the mushrooms or mushroom slices.

Typically, after dirt and debris have been removed from the mushroom and/or mushroom slice, the mushrooms are stored until they are dry, under conditions chosen by those of skill in the art. It is to be appreciated that any apparatus may be used to store the mushrooms while they dry. For example, a baking sheet or other flat surface can be used.

After the mushrooms are optionally dried to a desired moisture content, the mushrooms may be stored in a refrigerator to make firm. Firm mushrooms tend to be easier to slice, as compared to wet and/or soggy mushrooms. It is to be appreciated that the mushrooms may be cooled in any method chosen by one of skill in the art to lower a temperature to a suitable range for the mushrooms to be sliced.

The method may also include the step of disposing a seasoning on the mushroom slice. The step of disposing may be further defined as disposing the seasoning on and in direct contact with the mushroom slice or on and disposed apart from the mushroom slice. For example, the seasoning may be disposed on (and in direct contact with) the hydrolyzed animal and/or plant protein which itself is disposed on and in direct contact with the mushroom slice.

The step of disposing the seasoning is not particularly limited and may be further defined as any method known in the art. For example, the step of disposing may be further defined as spraying, dipping, sprinkling, basting and combinations thereof. The seasoning may be in liquid form, solid form and combinations thereof. In various embodiments, the step of disposing is further defined as disposing the seasoning on the mushroom slice such that the seasoning is present in an amount of from 1 to 20, from 1 to 10, or from 10 to 20, weight percent based on a total weight of the mushroom slice.

In various embodiments, the mushroom slice includes 80% to 85% moisture content by weight. After the step of baking and/or drying, the mushroom slice may have a moisture content of from 2% to 10% by weight. This reduction in moisture may enhance the texture of the foodstuff to be appealing to consumers and may also increase the shelf life of the foodstuff.

In some embodiments, the method may include the step of grinding the baked mushroom slice including the hydrolyzed protein (e.g. any embodiment described above) to be used as a flavoring ingredient. The grinding may be performed by a variety of methods. For example, the grinding may be carried out by cylindrical grinding, internal grinding, centerless grinding, surface grinding, and combinations thereof. Additionally, multiple different implements may be employed to perform the grinding. For example, ball mills, rod mills, autogenous mills, semi-autogenous grinding mills, pebble mills, high pressure grinding rolls, buhrstone mills, vertical shaft impactor mills (VSI mill), tower mills, and combinations thereof. The grinding step can cause the foodstuff to be a variety of particle sizes.

As it is known in the art, mesh sizes are commonly used to reduce a powder to a certain size. The powder may be any mesh size e.g. of from 2 to 635. Common mesh sizes used in the art may be 20, 30, 40, 50, 60, 70, 80, 100, 10/16, 16/20, 20/30, 30/60, 6/10, and combinations thereof. Alternatively, a sieve may be used to filter the powder to a particular size. For example, the ground foodstuff may be reduced to a size of from 150 to 710 micrometers. In various non-limiting embodiments, all values and ranges thereof including and between those values set forth above are hereby expressly contemplated for use.

In still other embodiments, the method may include the step of packaging the foodstuff. The packaging may be any known in the art. For example, the foodstuff may be placed in a package after it has cooled after baking or cooking. Alternatively, the foodstuff may be packaged raw. Packaging and package labeling typically have several objectives. Packaging the foodstuff into a bag tends to provide physical protection from shock, vibration, compression, temperature, bacteria, and other dangers possible to contaminate or damage the foodstuff. The packaging also tends to provide a barrier from oxygen, dust, water vapor, and other harmful substances that could negatively impact the taste, texture, and quality of the foodstuff. The packaging label can facilitate information transmission. Packaging labeling can be used for marketing the foodstuff, as well as providing the nutritional information to the consumer.

Any one or more steps described herein may be completed in a batch or continuous process and by hand or an automated or mechanized process.

### EXAMPLES

Various examples of the foodstuff of this disclosure are prepared, as described below. In these examples, mushroom slices of the species Pleurotus eryngii are formed. The mushroom slices have an approximate thickness of 0.2 cm and approximate dimensions of 5 cm diameter. The mushroom slices are cleaned prior to use using tap water. The mushroom slices are baked at a fixed temperature of 80° C. for a fixed amount of time of 8 hours in an electric convection oven.

There are six different samples prepared. Sample One has no hydrolyzed animal and/or plant protein disposed on the mushroom slice and is therefore a comparative example (control). Sample Two includes 10% hydrolyzed collagen protein disposed on the mushroom slice. Sample Three includes a 10% water soluble hydrolyzed collagen protein disposed on the mushroom slice. Sample Four includes a 20% hydrolyzed collagen protein disposed on the mushroom slice. Sample Five includes a 20% water soluble collagen protein disposed on the mushroom slice. Sample Six includes a 10% hydrolyzed soy protein disposed on the mushroom slice. For each of the Samples, the protein was disposed by way of dispensing. None of the Samples included any seasoning, any other additives, or any other proteins not described above.

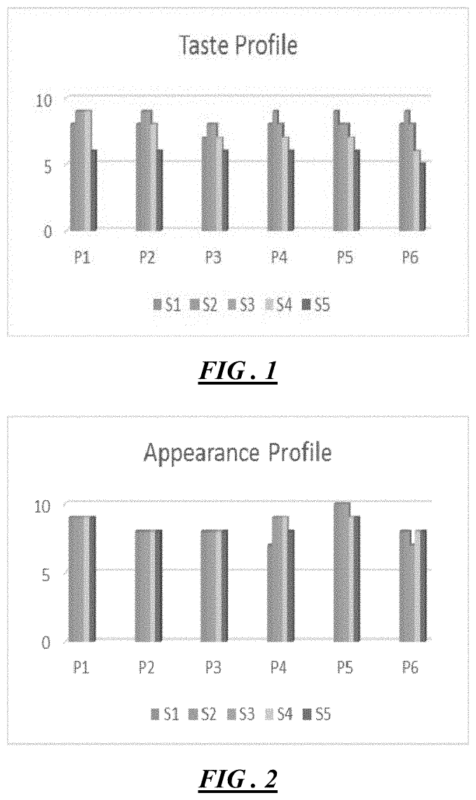

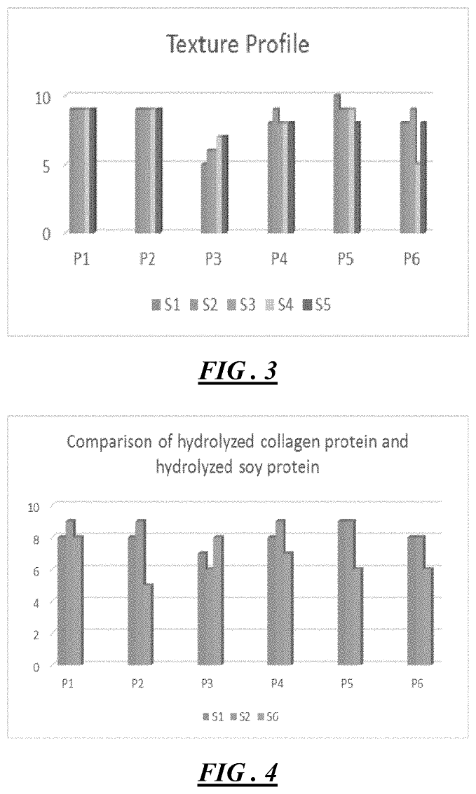

After baking, each of the six different Samples was evaluated using a variety of sensory tests by sensory evaluators. Six sensory evaluators are used for this evaluation (P1-P6). The sensory evaluators are asked to rank the samples, in a blind test form, on a scale from 0 to 10 for three different properties, wherein 0 is the lowest (and least favorable or preferred) score and 10 is the highest (or most favorable or preferred) score. The properties ranked are (1) taste, (2) texture, and (3) appearance. The results of this evaluation are set forth in FIGS. 1-4.

As shown in FIGS. 1-4, Sample One is evaluated to determine taste profile, appearance profile, texture profile, and comparison of hydrolyzed collagen protein and hydrolyzed soy protein.

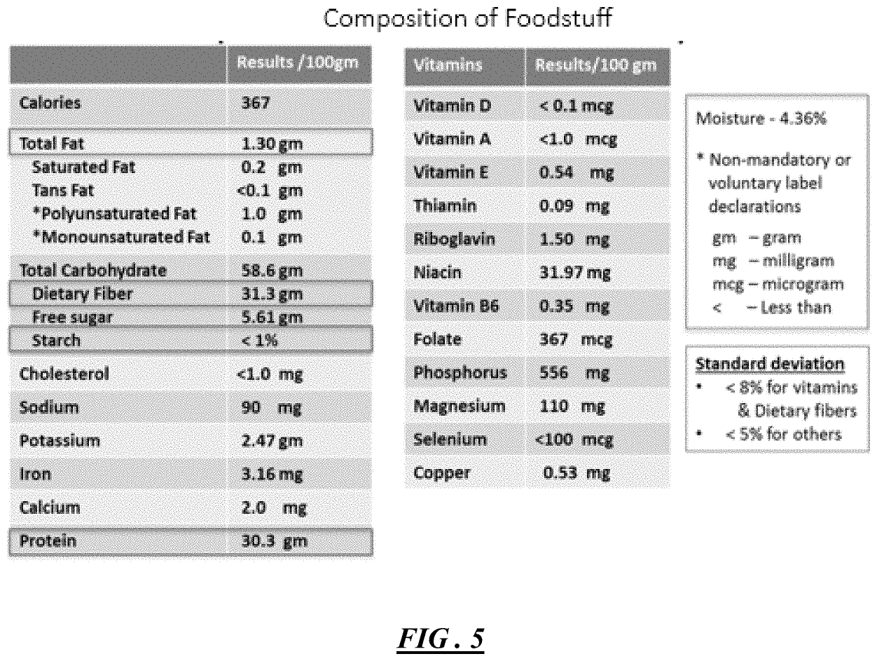

As shown in FIGS. 1-5, Sample Two is evaluated to determine taste profile, appearance profile, texture profile, comparison of hydrolyzed collagen protein and hydrolyzed soy protein, and composition of foodstuff.

As shown in FIGS. 1-3, Sample Three is evaluated to determine taste profile, appearance profile, and texture profile.

As shown in FIGS. 1-3, Sample Four is evaluated to determine taste profile, appearance profile, and texture profile.

As shown in FIGS. 1-3, Sample Five is evaluated to determine taste profile, appearance profile, and texture profile.

As shown in FIG. 4, Sample Six is evaluated to determine comparison of hydrolyzed collagen protein and hydrolyzed soy protein.

The following results are clearly understood from reviewing the Figures. Collagen protein has neutral taste, the taste of the mushroom crisp does not change between Sample One and Sample Two. However, as the concentration of the hydrolyzed collagen protein increases from 10% in Sample Two to 20% in Sample Three, Sample Three tastes slightly bitter and taste evaluation ranking decreases. Compared to using a hydrolyzed collagen protein, adding water soluble collagen protein shows slightly reduced taste evaluation ranking at 10% protein addition. When the protein addition is increased from 10% to 20%, even further reduced taste evaluation ranking is seen. This is theorized to result from the Sample becoming bitter. This could be due to water soluble hydrolyzed proteins tending to have a bitter taste. Increasing the protein addition beyond a certain concentration may make the Samples taste bitter. This trend can be seen from all six sensory evaluators.

The texture of the Samples (e.g. crispiness, sensation while crunching the foodstuff in the mouth) does not significantly change between the comparative Sample and Samples Three to Six among the evaluators. An anomaly was seen with evaluator P3 who mentions that the texture of the sample improves by adding more protein thereto. Another evaluator P6 mentions that adding 20% hydrolyzed collagen protein alters the texture of the Sample.

The appearance of Sample 1, as compared to Samples 2-5 could be undetected which may mean that the disposing of the hydrolyzed animal and/or plant protein on the mushroom slice has little to no effect on the appearance of the baked foodstuff.

The hydrolyzed collagen protein tends to be more soluble in water when compared to the hydrolyzed soy protein. Sample 6 having the hydrolyzed soy protein disposed on the mushroom slice shows lower appearance evaluations than Samples 1-5. This could be because the hydrolyzed soy protein leaves a layer which looks unappealing. Additionally, the taste profile of Sample 6, compared to samples 1-5, tends to be lower. This may be because the hydrolyzed soy protein has a taste of its own which negatively affects the overall taste of the foodstuff.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

What is claimed is:

1. A foodstuff comprising:
a mushroom slice having a native protein content; and
a hydrolyzed animal and/or plant protein disposed on said mushroom slice to increase a total protein content thereof;
wherein said total protein content of said mushroom slice comprising the hydrolyzed animal and/or plant protein is 10 to 50 weight percent greater than that native protein content.

2. The foodstuff as set forth in claim 1, wherein said mushroom slice and said hydrolyzed animal and/or plant protein disposed thereon, are baked in an oven at a temperature of from 60° C. to 100° C. for a time of from 2 to 8 hours.

3. The foodstuff as set forth in claim 1, further comprising a seasoning disposed on said mushroom slice.

4. The foodstuff as set forth in claim 3, wherein said seasoning is chosen from all-spice, coriander, cumin, oregano, garlic powder, cinnamon, chili powder, nutmeg, cloves, ginger, thyme, rosemary, cardamom, paprika, turmeric, cayenne pepper, bay leaves, cajun seasoning, basil, garlic, curry powder, garam masala, jalapeno, cheese, salt, pepper, sugar, onion powder, lemon, barbeque flavoring, chocolate, coco powder, fruit, freeze dried fruit, artificial fruit flavoring, coffee, tea and combinations thereof.

5. The foodstuff as set forth in claim 1, wherein said mushroom is of the mushroom species Pleurotus eryngii.

6. The foodstuff as set forth in claim 1, wherein said mushroom slice has a thickness of from 1 mm to 5 mm.

7. The foodstuff as set forth in claim 1, wherein said hydrolyzed animal and/or plant protein is chosen from pea, soy, milk, egg, rice, collagen, and combinations thereof.

8. A method of preparing a foodstuff, said method comprising the steps of:
slicing a mushroom to form a mushroom slice wherein the mushroom slice has a native protein content; and
disposing a hydrolyzed animal and/or plant protein on the mushroom slice to increase a total protein content 10 to 50 weight percent greater than the native protein content.

9. The method as set forth in claim 8 further comprising the step of baking the mushroom slice and the hydrolyzed animal and/or plant protein disposed thereon at a temperature of from of 60° C. to 100° C. for a time of from 2 to 8 hours to form the foodstuff.

10. The method as set forth in claim 9, further comprising the step of grinding the foodstuff into a powder.

11. The method as set forth in claim 8, further comprising the step of cleaning the mushroom prior to the step of slicing.

12. The method as set forth in claim 8, further comprising the step of drying the mushroom slice.

13. The method as set forth in claim 8, further comprising the step of disposing a seasoning on the mushroom slice.

14. The method as set forth in claim 8, wherein said step of disposing the hydrolyzed animal and/or plant protein is further defined as spraying the hydrolyzed animal and/or plant protein onto the mushroom slice.

15. The method as set forth in claim 8, wherein said step of disposing the hydrolyzed plant and/or animal protein is further defined as dipping the mushroom slice in a solution of the hydrolyzed animal and/or plant protein.

16. The method as set forth in claim 8, wherein said step of disposing the hydrolyzed plant and/or animal protein is further defined as dispensing the hydrolyzed animal and/or plant protein onto the mushroom slice.

17. The method as set forth in claim 8, wherein the mushroom is of the mushroom species Pleurotus eryngii.

18. The method as set forth in claim 8, wherein said step of slicing the mushroom is further defined as slicing the mushroom to a thickness of from 1 mm to 5 mm.

19. The method as set forth in claim 8, further comprising the step of packaging the foodstuff.

20. The method as set forth in claim 9, wherein the baked mushroom slice has a moisture content of from 2 to 10 percent by weight.
